(19) United States
(12) Patent Application Publication
(10) Pub. No.: US 2019/0271378 A1
(43) Pub. Date: Sep. 5, 2019

(54) DRIVE MECHANISM FOR USE WITH AN IMPLEMENT

(71) Applicant: MULTI-TIP DESIGNS LIMITED, OXFORDSHIRE (GB)

(72) Inventor: PATRICK WATTS, OXFORDSHIRE (GB)

(21) Appl. No.: 16/461,213

(22) PCT Filed: Nov. 17, 2017
(86) PCT No.: PCT/GB2017/053466

§ 371 Date: May 15, 2019

(30) Foreign Application Priority Data
Nov. 18, 2016 (GB) 1619575.2

(51) Int. Cl. F16H 9/06; F16H 9/24; A01G 23/06; E02F 9/20; E02F 5/08

(52) U.S. Cl. CPC F16H 9/06; F16H 9/24; A01G 23/067; A01G 3/086; E02F 5/08; F16H 2009/245; E02F 9/202

(57) ABSTRACT

A drive mechanism for use with an implement comprising a driving sprocket to drive a rotatable workpiece and at least one intermediate sprocket of different diameter to the driving sprocket to allow for change of speed and torque of the rotatable workpiece.

The present invention relates to a drive mechanism and particularly to a drive mechanism for use with an implement for cutting materials.

According to the invention, there is provided a drive mechanism for use with an implement comprising a driving sprocket to drive a rotatable workpiece and at least one intermediate sprocket of different diameter to the driving sprocket to allow for change of speed and torque of the rotatable workpiece.

Preferably, there is provided a drive mechanism for use with a hand-operated implement for cutting materials.

In another embodiment, there may be provided a drive mechanism for use with a mechanically or electronically operated implement for cutting materials.

Preferably, the rotatable workpiece comprises a rotatable wheel or component.

It is preferred that the intermediate sprocket is an intermediate stepped sprocket.

Preferably, the drive mechanism comprises a drive train.

Preferably, the or each intermediate sprocket is mounted for free longitudinal movement within a hollow shaft to allow for two or more chains to be tightened equally and/or together.

Preferably, there is provided a drive train for use with an implement comprising a driving sprocket to drive a rotatable wheel or component, with at least one intermediate, stepped sprocket of different diameter to the driving sprocket to change the speed and torque of the rotatable wheel or component, wherein the, or each intermediate sprocket is mounted for free longitudinal movement within a hollow shaft to allow for two or more chains to be tighten equally and together.

Preferably, the chains and/or sprockets may be belts and/or pulleys.

Preferably, the driving sprocket is used with a stump grinder, preferably a hand-held tree stump grinder.

Preferably, the or each intermediate sprocket is mounted for free longitudinal movement within a shaft.

Preferably, the drive mechanism includes tensioning means.

Preferably, the tensioning means comprises an attachment part of an intermediate sprocket dispersed adjacent the drive means.

According to a second aspect there is provided a stump grinder comprising a drive mechanism according to the first aspect of the invention.

Preferably, the stump grinder includes a handle and a shaft, wherein the handle pivots about the shaft.

Preferably, the stump grinder comprises a support for supporting the foot of a user.

Preferably, the stump grinder comprises a quick release mechanism, preferably for release of the handle of the grinder.

According to a third aspect, there is provided a trenching device comprising a drive mechanism according to the first aspect of the invention.

According to a fourth aspect, there is provided a method of varying the speed and torque of a rotatable workpiece, comprising the steps of using a drive mechanism for use with a hand-operated implement for cutting materials comprising a driving sprocket to drive a rotatable workpiece and at least one intermediate sprocket of different diameter to the driving sprocket to allow for variation of speed and torque of the rotatable workpiece.

According to a fifth aspect, there is provided a method of grinding a stump comprising the step of using apparatus as defined hereabove.

The invention will be further described by way of example, with reference to the accompanying drawings, in which:

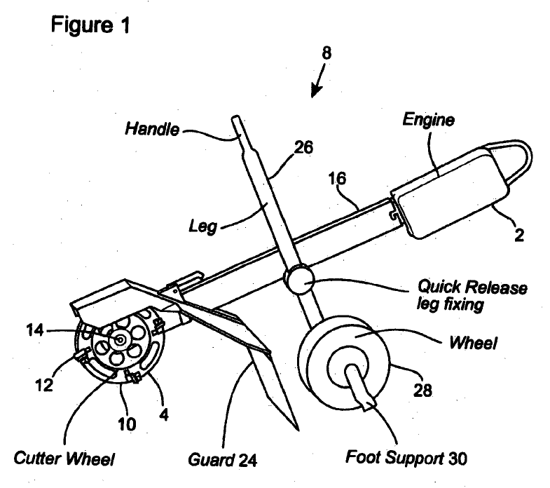

FIG. 1 is a perspective side view of a hand-operated implement comprising the drive mechanism according to an embodiment of the invention;

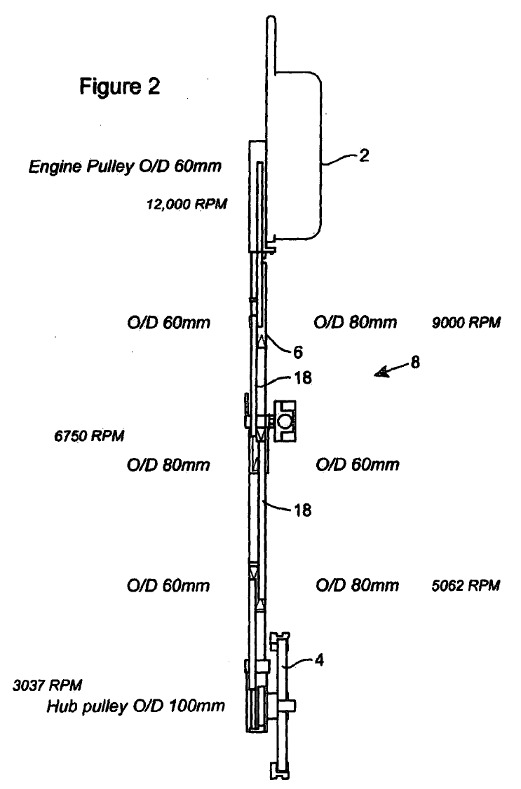

FIG. 2 is a schematic side view of a hand-operated implement comprising the drive mechanism according to an embodiment of the invention;

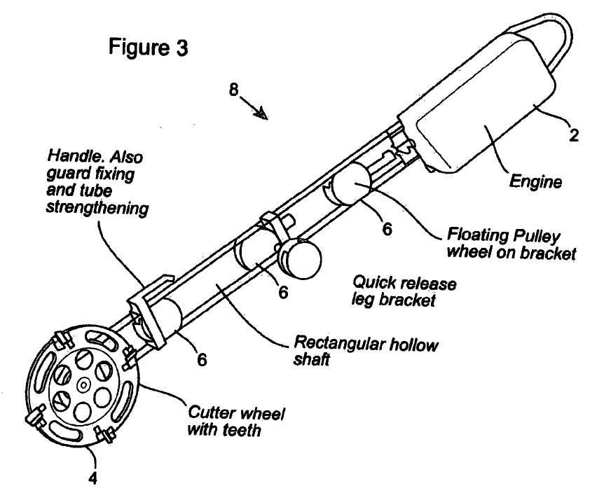

FIG. 3 is a perspective side view of a hand-operated implement comprising the drive mechanism according to an embodiment of the invention;

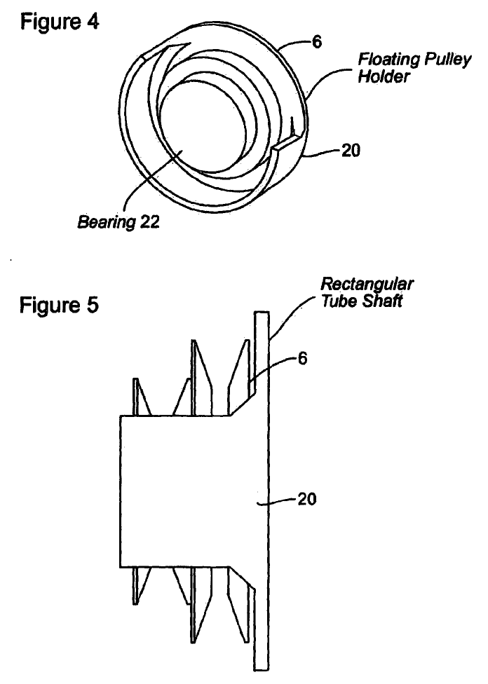

FIG. 4 is a perspective view of an intermediate sprocket according to an embodiment of the invention;

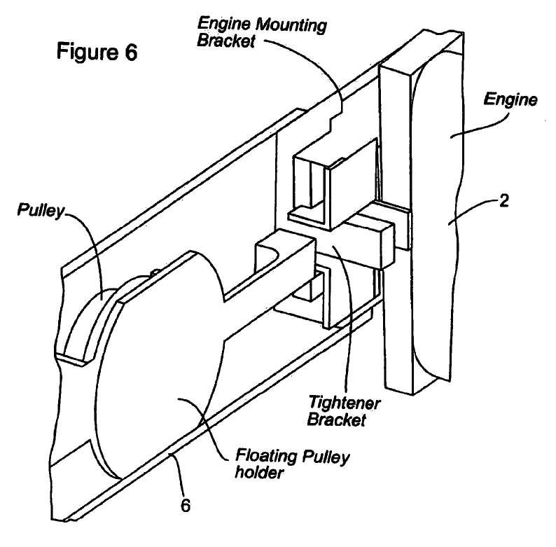

FIG. 5 is a side schematic view of a tube shaft of a hand-operated implement comprising the drive mechanism according to an embodiment of the invention;

FIG. 6 is a perspective view of part of a hand-operated implement comprising the drive mechanism according to an embodiment of the invention;

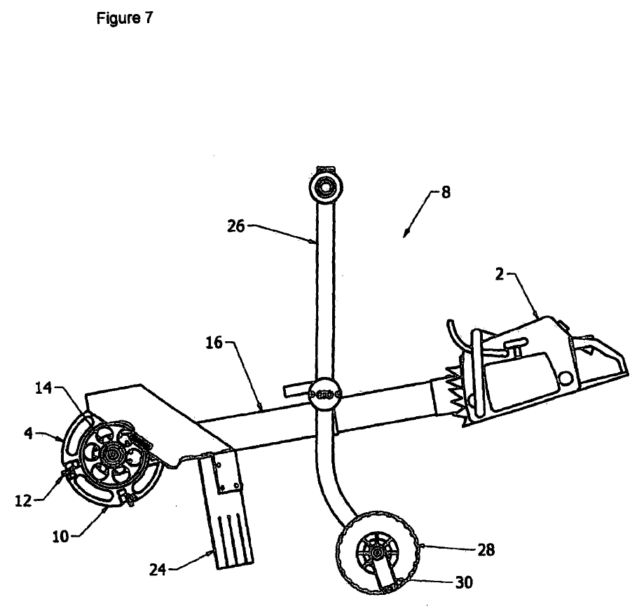

FIG. 7 is a perspective side view of an alternate embodiment of a hand-operated implement comprising the drive mechanism according to an embodiment of the invention;

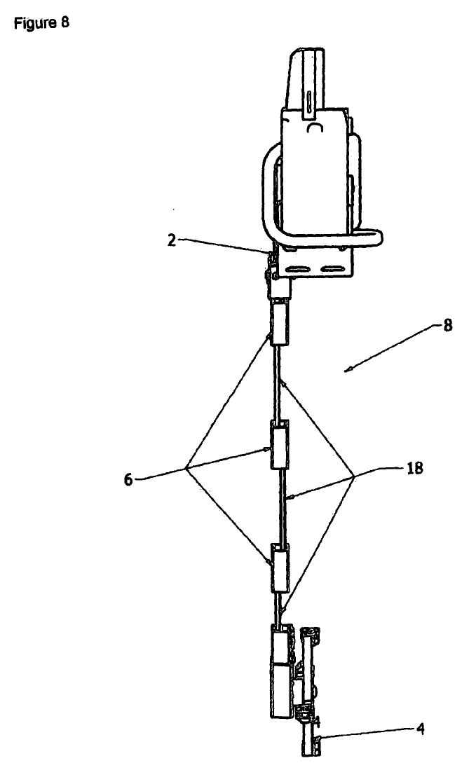

FIG. 8 is a schematic side view of an alternate embodiment of a hand-operated implement comprising the drive mechanism according to an embodiment of the invention;

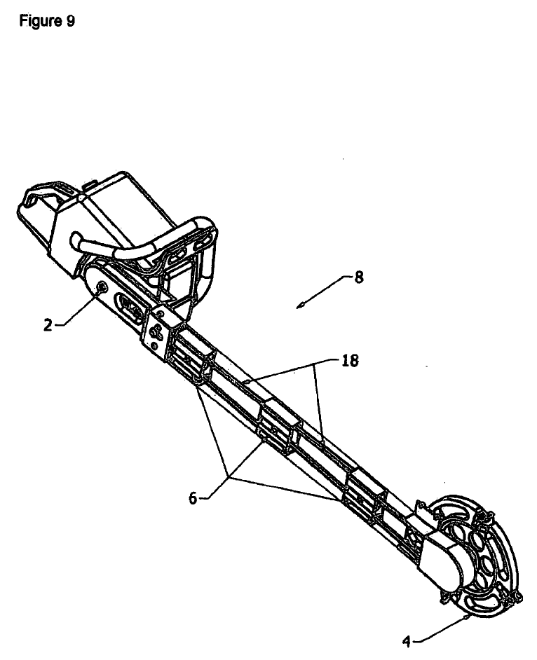

FIG. 9 is a perspective side view of an alternate embodiment of a hand-operated implement comprising the drive mechanism according to an embodiment of the invention;

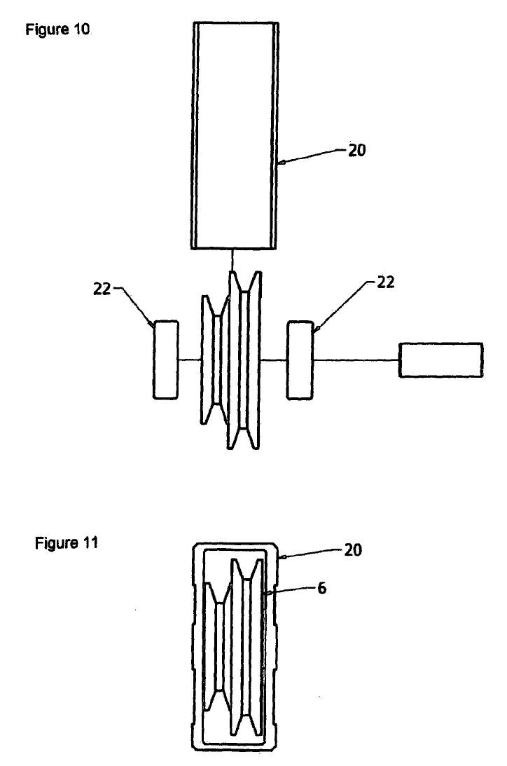

FIG. 10 is a perspective view of an alternate embodiment of an intermediate sprocket according to an embodiment of the invention; and

FIG. 11 is a side schematic view of an alternate embodiment of a tube shaft of a hand-operated implement comprising the drive mechanism according to an embodiment of the invention.

With reference to the drawings, there is provided a drive mechanism (or drive train) for use with an implement for cutting materials comprising a driving sprocket 2 to drive a rotatable workpiece 4 and at least one intermediate sprocket 6 of different diameter to the driving sprocket to allow for variation or change of speed and torque of the rotatable workpiece.

With reference to the figures, the drive mechanism is for use with a hand-operated implement for cutting materials. However, in other embodiments, there may be provided a drive mechanism for use with a mechanically or electronically operated implement for cutting materials.

With reference, for example, to FIG. 1, there is provided a drive train for use with an implement comprising a driving sprocket 2 to drive a rotatable wheel or component 4, with at least one intermediate, stepped sprocket 6 of different diameter to the driving sprocket to change the speed and torque of the rotatable wheel or component, wherein the, or each intermediate sprocket is mounted for free longitudinal movement within a hollow shaft to allow for two or more chains to be tighten equally and together.

The driving sprocket 2 may be used with a hand-operated implement 8 such as a tree stump grinder.

The hand-operated implement 8 is advantageously a lightweight machine, typically weighing under 25 kg and powered by a chainsaw engine.

The machine consists of a cutter wheel 10 with teeth 12 which is mounted onto a stub shaft 14 which is fitted into a hub with roller bearing support. Off the other end of the stub shaft, within the hub is a pulley wheel.

The hub is attached to a hollow, rectangular tube 16 which contains a series of stepped, floating, pulleys 6 connected by separate belts 18. This provides the reduction in gearing from the engine to the cutter wheel. The engine RPM is around 12,000 and the required speed for the cutter wheel is around 3,000.

In one embodiment, the belts 18 are tensioned at the engine end of the shaft but not using the engine. In a further embodiment, the assembly is pre-tensioned before fitting the engine.

As the series of pulleys are floating within the shaft, the belts 18 can all be tension together equally.

In one embodiment, the pulleys are mounted onto the floating pulley holders 20 with a bearing 22 and held in place onto the floating holder with a shaft. In another embodiment, the pulleys are mounted onto the floating pulley holders 20 with a bearing 22 and held tightly in place onto the floating holder with a bolt.

The pulley holders will fit snuggly within the shaft with free movement in only one axis until the belts are tensioned. A simple mechanism pulls the pulley holder nearest to the engine end, which in turn pulls the next pulley, which pulls the third floating pulley, which tightens up the whole assembly because the final pulley wheel that is in the hub is not floating. In one embodiment, the simple mechanism is a single bolt.

More pulley wheels can be added if necessary to reduce the final speed further, which might be required for other applications.

The engine is then attached to the shaft and there is another belt between the engine pulley and the first pulley within the shaft. This could be tensioned separately by pushing the engine away from the end of the shaft.

In use, the operator wheels the machine to the tree stump, puts his foot on the bottom of the leg and proceeds to cut slices out of the stump using the handle on the top of the leg to push the machine forward whilst raising the engine with his right hand. His right hand adjusts the throttle control accordingly.

Thus, the present invention preferably relates to a floating pulley system within the shaft of a hand-operated implement with easy tensioning.

The hand-held implement may further comprise a guard 24 which preferably comprises a flexible material such as polycarbonate. Advantageously, the guard may be replaceable at low cost.

Some of the advantages of the invention are that the hand-operated implement is typically lighter in weight and less expensive than previous hand-operated implements comprising a drive means; may comprise a quick release handle 26; may allow for easy belt tensioning; may allow a user to swap with a chainsaw blade in seconds; may allow for a quick change when using with a high performance multi-tip system; may allow for variable gearing for different engines; may comprise a wheel 28 on the leg of the hand-held implement for easy manoeuvrability. The wheel 28 may comprise a foot support 30.

The present invention advantageously provides a system where the speed may be reduced with a number of stepped pulleys. The belts 18 within the machine can advantageously be pre tensioned before fitting the engine, allowing for very quick changing of the engine such that the user can switch from stump grinder to chainsaw blade in two or three minutes.

FIGS. 7 to 11 show an alternate embodiment of the present invention. Reference numerals indicate the same features as for FIGS. 1 to 6.

1. A drive mechanism for use with an implement comprising a driving sprocket to drive a rotatable workpiece and at least one intermediate sprocket of different diameter to the driving sprocket to allow for change of speed and torque of the rotatable workpiece.

2. The drive mechanism of claim 1, wherein the drive mechanism is for use with a hand-operated implement for cutting materials.

3. The drive mechanism of claim 1, wherein the drive mechanism is for use with a mechanically or electronically operated implement for cutting materials.

4. The drive mechanism of claim 1, wherein the drive mechanism comprises a drive train.

5. The drive mechanism of claim 1 for use with a stump grinder.

6. The drive mechanism of claim 1 wherein the or each intermediate sprocket is mounted for free longitudinal movement within a shaft.

7. The drive mechanism of claim 1 including tensioning means.

8. The drive mechanism of claim 7, wherein the tensioning means comprises an attachment part of an intermediate sprocket dispersed adjacent the drive means.

9. The drive mechanism of claim 1, wherein the rotatable workpiece comprises a rotatable wheel or component.

10. The drive mechanism of claim 1, wherein the intermediate sprocket is an intermediate stepped sprocket.

11. The drive mechanism of claim 1, wherein the or each intermediate sprocket is mounted for free longitudinal movement within a hollow shaft to allow for two or more chains to be tightened equally and/or together.

12. The drive mechanism of claim 11, wherein the chains and/or sprockets may be belts and/or pulleys.

13. A stump grinder comprising a drive mechanism according to claim 1.

14. The stump grinder of claim 13 comprising a handle and a shaft, wherein the handle pivots about the shaft.

15. The stump grinder of claim 12 comprising a support for supporting the foot of a user.

16. The stump grinder of claim 12 comprising a quick release mechanism for release of the handle of the grinder.

17. A trenching device comprising a drive mechanism according to claim 1.

18. A method of varying the speed and torque of a rotatable workpiece, comprising the steps of using a drive mechanism for use with a hand-operated implement for cutting materials comprising a driving sprocket to drive a rotatable workpiece and at least one intermediate sprocket of different diameter to the driving sprocket to allow for variation of speed and torque of the rotatable workpiece.

19. A method of grinding a stump comprising the step of using the drive mechanism claim 1.

20. A drive train for use with an implement comprising a driving sprocket to drive a rotatable wheel or component, with at least one intermediate, stepped sprocket of different diameter to the driving sprocket to change the speed and torque of the rotatable wheel or component, wherein the or each intermediate sprocket is mounted for free longitudinal movement within a hollow shaft to allow for two or more chains to be tighten equally and together at one end.

21-25. (canceled)
